(19) United States
(12) Patent Application Publication
(10) Pub. No.: US 2011/0231866 A1
(43) Pub. Date: Sep. 22, 2011

(54) MOTOR

(75) Inventor: Nobuaki Yasumoto, Minami-ku (JP)

(73) Assignee: NIDEC CORPORATION, Minami-ku (JP)

(21) Appl. No.: 13/051,330

(22) Filed: Mar. 18, 2011

Related U.S. Application Data
(60) Provisional application No. 61/315,169, filed on Mar. 18, 2010.

(51) Int. Cl. G11B 7/00

(52) U.S. Cl. 720/661; G9B/7

(57) ABSTRACT

There is provided a motor for a disk drive apparatus. The motor includes a cone member, a substantially annular back yoke, a substantially annular clamp magnet, an adhesive agent, and a motor unit. A storage portion includes a clamper insertion portion formed in a position axially overlapping with the clamp magnet to accommodate the clamper when the clamper comes closer to the cone member. The back yoke includes a first surface opposed to the clamp magnet in a contact or adjoining relationship therewith and a second surface positioned near the clamper insertion portion and kept spaced apart from the clamp magnet. The cone member includes an adhesive agent staying portion arranged to accommodate a part of the adhesive agent. The adhesive agent stays portion being defined between the imaginary surface extending axially downwards from the circumferential surface of the clamp magnet facing the clamper insertion portion.

The disclosure of Japanese Patent Application No. 2009-050690 filed on Mar. 4, 2009 including the specification, drawings and abstract is incorporated herein by reference in its entirety.

### BACKGROUND OF THE INVENTION

1. Field of the Invention

The present invention relates to a motor for a disk drive apparatus.

2. Description of the Related Art

In an apparatus for driving an optical disk such as a DVD or a CD-ROM (hereinafter just referred to as “disk”), the task of bringing the rotation center of the disk into alignment with the rotation axis of a motor employed as a rotational drive device for a disk information recording and reproducing apparatus is called “centering”. The centering has been conventionally performed by means of a centering member provided in a motor for rotationally driving a disk.

The disk has an attachment hole with an inner diameter and an axial thickness specified by standards. A turntable is fixedly secured to the motor. A cushion sheet is attached to the upper surface of the turntable with increased vertical deflection accuracy. A centering member for centering the disk is provided in the central area of the turntable. The centering member includes a plurality of centering claws elastically displaceable in the radial direction. The disk is mounted on the turntable and centered by the centering claws.

A clamper is positioned at the upper side of the motor. The clamper includes a clamper yoke made of a magnetic material. The clamper yoke is attracted toward a clamp magnet provided inside the centering member. The clamper serves to fix the disk between itself and the turntable. In the course of fixing the disk, the clamper is guided along the inner circumferential surface of the centering member and is centered with respect to the rotation axis.

In recent years, there exists an increasing demand for thickness reduction of an information recording and reproducing apparatus. In view of this, it is thinkable to reduce the thickness of a motor mounted inside the information recording and reproducing apparatus and provided with a centering member for removably holding a disk. However, it is difficult to accomplish the motor thickness reduction without sacrificing the characteristics of the motor or the performance thereof as a centering mechanism. In case of attempting to reduce the thickness of the centering member, the axial thickness of a back yoke or a clamp magnet attached to the inner surface of the centering member needs to be taken into account. There is a fear that the thickness reduction of the back yoke or the clamp magnet may not only reduce the disk holding force but also adversely affect the reliability of the information recording and reproducing apparatus.

A mechanism for guiding the clamper needs to be provided at the side of the centering member. However, it is necessary to bring the axis of the centering member into alignment with the rotation axis of the motor. In an effort to secure the fixing strength of the centering member to a rotating body, the substantially entire area of the inner circumferential surface of the centering member is used in fixing the centering member to the rotating body. This means that the mechanism for guiding the clamper cannot be provided on the inner circumferential surface of the centering member.

The conventional centering member is thicker than a motor in which the flat portion making contact with the lower surface of the back yoke has a reduced axial thickness. This makes it possible to increase the axial bonding dimension needed for fixation of the centering member to the motor. In order to reduce the thickness of the centering member, however, it is not desirable to increase the axial bonding dimension.

### SUMMARY OF THE INVENTION

In accordance with a first aspect of the present invention, there is provided a motor for a disk drive apparatus, which is rotatable about a rotation axis and arranged to hold a disk in cooperation with a clamper provided in a disk drive apparatus body, the motor including:

a cone member including a flat portion extending radially away from the rotation axis, a guide portion arranged radially outwards of the flat portion and provided with a guide surface for guiding the inner edge portion of the disk and a storage portion positioned above the flat portion and radially inwards of the guide portion; a substantially annular back yoke arranged within the storage portion of the cone member; a substantially annular clamp magnet positioned axially above the back yoke to attract the clamper; an adhesive agent arranged to fix the clamp magnet to one or both of the cone member and the back yoke; and a motor unit arranged to rotate the cone member, wherein the storage portion includes a clamper insertion portion formed in a position axially overlapping with the clamp magnet to accommodate the clamper when the clamper comes closer to the cone member, the back yoke including a first surface opposed to the clamp magnet in a contact or adjoining relationship therewith and a second surface positioned near the clamper insertion portion and kept spaced apart from the clamp magnet, the cone member including an adhesive agent staying portion arranged to accommodate a part of the adhesive agent, the adhesive agent staying portion being defined between the imaginary surface extending axially downwards from the circumferential surface of the clamp magnet facing the clamper insertion portion, the lower surface of the clamp magnet and the back yoke including the second surface or between the imaginary surface, the lower surface of the clamp magnet, the back yoke including the second surface and the upper surface of the cone member.

With the motor of the first aspect of the present invention, it is possible to position the clamper in exact alignment with the rotation axis of the motor despite the reduction in the thickness of the motor. This makes it possible to reduce the thickness of the centering unit while assuring the necessary and sufficient centering accuracy.

### BRIEF DESCRIPTION OF THE DRAWINGS

FIG. 1 is a vertical section view showing a disk drive apparatus.

FIG. 2 is a vertical section view showing a motor.

FIG. 3 is a top plan view showing a cone.

FIG. 4 is a section view of the cone taken along line R-O-S in FIG. 3.

FIG. 5 is a bottom view of the cone shown in FIG. 3.

FIG. 6 is a top plan view showing a back yoke.

FIG. 7 is a vertical section view of the back yoke taken along line P-O-Q in FIG. 6.

FIG. 8 is a vertical section view of the cone taken along line R-O-S in FIG. 3, with the back yoke fusion-fixed to the cone shown in FIG. 4.

FIG. 9 is a flow chart illustrating the manufacturing sequence of a centering unit.

FIG. 10 is a schematic diagram showing a supporting jig and a pressing jig used in the manufacture of the centering unit.

FIG. 11 is an exploded perspective diagram schematically showing the supporting jig, the cone and the back yoke, all of which are brought into alignment with the same axis.

FIG. 12 is a view showing the centering unit under manufacture, in which view the back yoke is pressed by a pressing member.

FIG. 13 is a view showing the centering unit under manufacture, in which view each of the protrusion portions of the cone is being melt by means of a horn.

FIG. 14 is a section view showing a cone, a back yoke and a clamp magnet according to another embodiment.

FIG. 15 is a section view showing a cone, a back yoke and a clamp magnet according to a further embodiment.

FIG. 16 is a section view showing a cone, a back yoke and a clamp magnet according to a still further embodiment.

FIG. 17 is a section view showing a cone, a back yoke and a clamp magnet according to a yet still further embodiment.

FIG. 18 is an enlarged view of an adhesive agent staying portion shown in FIG. 8.

Hereinafter, preferred embodiments of the present invention will be described with reference to the accompanying drawings.

### 2-1. Configuration of Disk Drive Apparatus

In the following description on the shape and positional relationship of individual members, the direction running along the center axis 9 will be referred to as “up-down direction”. The term “upper” refers to the side at which a clamper 13 is positioned with respect to a disk 90 held by a chucking device 4, while the term “lower” refers to the side at which a rotor holder 42 is positioned with respect to the disk 90. However, these definitions are presented merely for the sake of convenience in description and are not intended to limit the installation postures of the motor of the present invention, the motor manufactured by the present manufacturing method and the disk drive apparatus when they are mounted to actual devices.

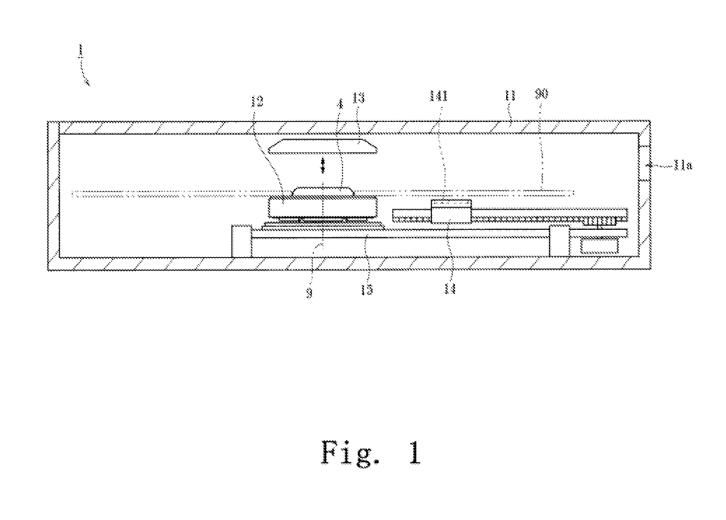

FIG. 1 is a vertical section view showing a disk drive apparatus 1. The disk drive apparatus 1 is an apparatus arranged to read or write information from or on an optical disk 90 while rotating the optical disk 90 about the center axis 9. In the following description, the optical disk 90 will be just referred to as “disk 90”. As shown in FIG. 1, the disk drive apparatus 1 includes an apparatus housing 11, a motor 12, a clamper 13 and a recording and reproducing unit 14.

The apparatus housing 11 is a frame arranged to accommodate the motor 12, the clamper 13 and the recording and reproducing unit 14 therein. The apparatus housing 11 has an opening 11a through which the disk 90 is conveyed into and taken out of the apparatus housing 11. The motor 12 is fixed to a chassis 15 provided within the apparatus housing 11. The motor 12 includes a chucking device 4 arranged to hold the disk 90 thereon. The disk 90 conveyed into the apparatus housing 11 is held between the chucking device 4 and the clamper 13 and is rotated about the center axis 9 by means of the motor 12.

The recording and reproducing unit 14 moves an optical pickup unit 141 arranged to move along the recording surface of the disk 90 rotated by the motor 12 to read or write information from or on the disk 90. Alternatively, the optical pickup unit 141 of the recording and reproducing unit 14 may be of the type capable of reading and recording information with respect to the disk 90.

### 2-2. Configuration of Motor

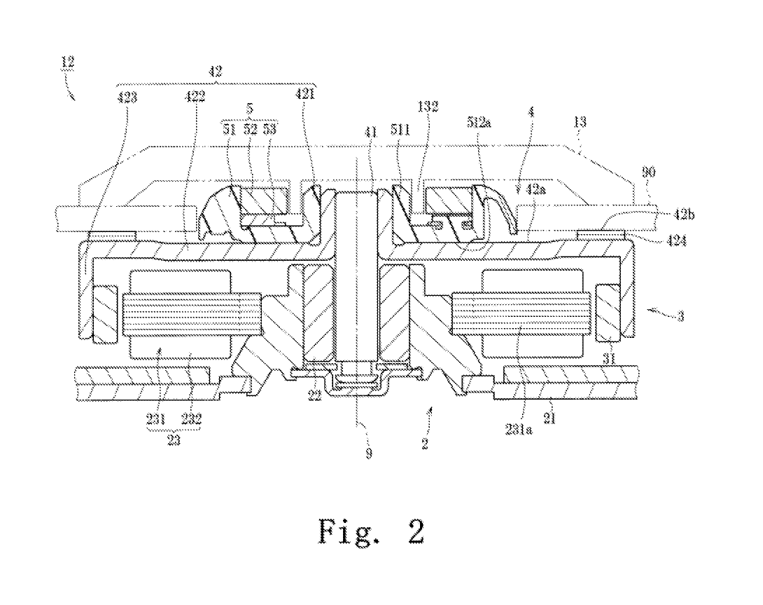

Next, description will be made on the configuration of the motor 12. FIG. 2 is a vertical section view showing the motor 12. As shown in FIG. 2, the motor 12 includes a stationary unit 2 fixed to the chassis 15 of the disk drive apparatus 1, a rotary unit 3 supported for rotation with respect to the stationary unit 2 and a chucking device 4 arranged above the rotary unit 3 to rotate together with the rotary unit 3 while centering the disk 90.

The stationary unit 2 includes a base member 21, a bearing unit 22 fixed to the base member 21 and a magnetic flux generating unit 23. The bearing unit 22 is a mechanism arranged to support a shaft 41 in a rotatable manner. The magnetic flux generating unit 23 includes a stator core 231 with a plurality of tooth portions 231a, and coils 232 wound on the respective tooth portions 231a.

The rotary unit 3 includes the shaft 41, a rotor holder 42 and a rotor magnet 31. The shaft 41 is a substantially cylindrical columnar member extending in the vertical direction along the center axis 9. The rotor holder 42 is fixed to the shaft 41 for rotation therewith. The rotor holder 42 has a substantially cylindrical shape with a cover and is made of, e.g., a magnetic material. The rotor magnet 31 has an annular shape, the inner circumferential surface of which serves as a magnetic pole surface opposing to the end surfaces of the tooth portions 231a of the stator core 231.

If a drive current is applied to the coils 232 of the stationary unit 2, there is generated magnetic flux flowing through the tooth portions 231a of the stator core 231. Circumferential torque is generated by the magnetic flux acting between the tooth portions 231a and the rotor magnet 31. As a result, the rotary unit 3 is rotated about the center axis 9 with respect to the stationary unit 2.

The chucking device 4 is a member common to the rotary unit 3 and includes the shaft 41 and the rotor holder 42. The chucking device 4 further includes a centering unit 5 arranged to bring the rotation center of the disk 90 into alignment with the rotation center of the motor 12 for rotationally driving the disk 90. The centering unit 5 includes a cone 51, a clamp magnet 52 and a back yoke 53.

The rotor holder 42 includes a first cylinder portion 421, a flange portion 422 and a second cylinder portion 423. The first cylinder portion 421 is fixed to the shaft 41. The flange portion 422 extends radially outwards from the lower end of the first cylinder portion 421. The second cylinder portion 423 extends downwards from the outer edge of the flange portion 422. A ring-shaped rubber member 424 made of a material with an increased frictional coefficient is fixed to the top surface 42a that makes up the upper surface of the flange portion 422 and expands radially outwards away from the center axis 9. The disk 90 is mounted on the flange portion 422 in a state that the lower surface of the disk 90 makes contact with the upper surface 42b of the rubber member 424. In the present embodiment, the rubber member 424 makes up a disk mounting portion and the upper surface 42b of the rubber member 424 serves as a disk mounting surface.

The cone 51 is a member (cone member) arranged to support the periphery of an attachment hole defined at the center of the disk 90, i.e., the inner circumferential portion of the disk 90. The cone 51 is arranged in a coaxial relationship with the rotation axis (or the center axis 9) and is fixed to the rotor holder 42. More specifically, the inner circumferential surface of the cone 51 comes into contact with the outer circumferential surface of the first cylinder portion 421 of the rotor holder 42. In the present embodiment, the top surface 42a making up the upper surface of the rotor holder 42 and the planar surface 512a making up the lower surface of the cone 51 are opposed to each other with a minute axial gap (of, e.g., about 30 μm) left therebetween. It is sometimes the case that a part of the adhesive agent applied between the inner circumferential surface of the cone 51 and the outer circumferential surface of the first cylinder portion 421 of the rotor holder 42 flows into the minute gap and stays between the top surface 42a and the planar surface 512a. Alternatively, the planar surface 512a of the cone 51 may remain in contact with the top surface 42a of the flange portion 422 of the rotor holder 42. Needless to say, the method of fastening the cone 51 and the rotor holder 42 together is not limited thereto. Press-fit may be used independently or press-fit and bonding may be used in combination. It may also be possible to use insert-molding, fusion bonding or other fastening methods.

The material of the cone 51 preferably includes, but is not limited to, a polycarbonate resin. For example, it may be possible to use a thermoplastic resin such as polyacetal, nylon, polyamide imide (PAI), polyether ether ketone (PEEK), thermoplastic polyimide (TPI), polytetrafluoroethylene (PTFE), polyphenylene sulfide (PPS), polybutylene terephthalate (PBT) or polyether imide (PEI). A mixture of two or more kinds of thermoplastic resins may be used. It may also be possible to use a thermosetting resin such as a phenol resin or the like or a mixture of a thermoplastic resin and a thermosetting resin.

### 2-3. Overall Shape of Cone

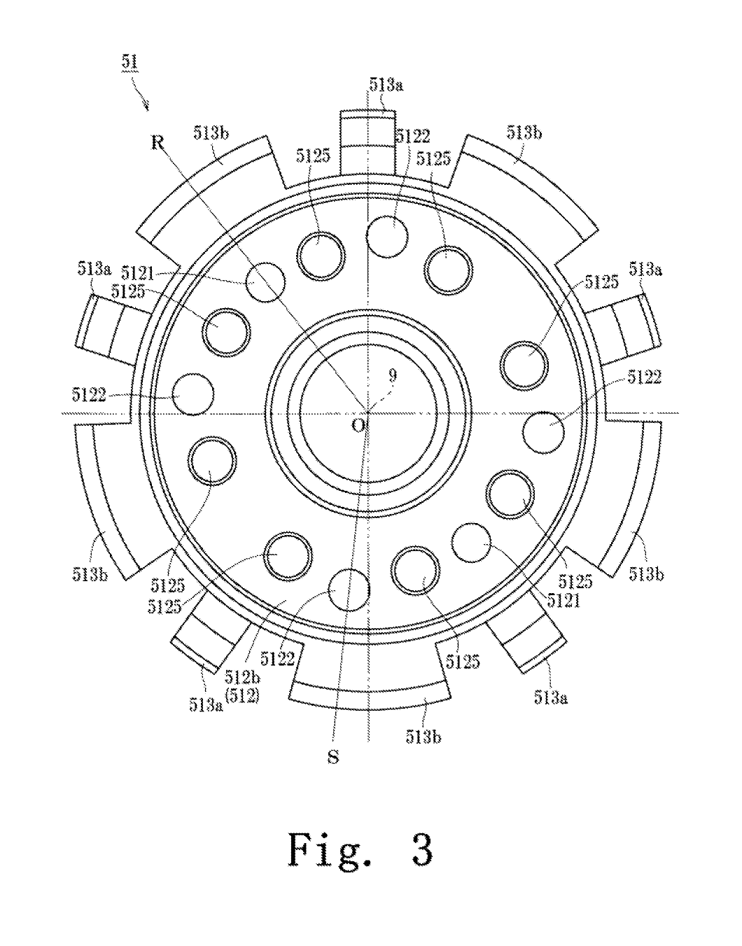

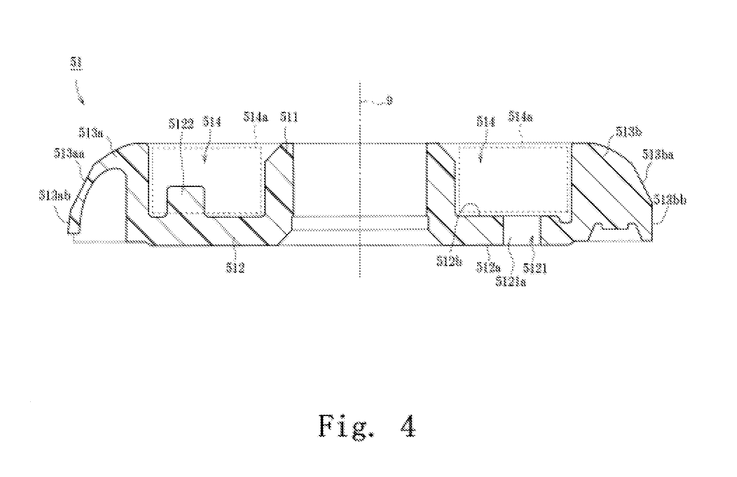

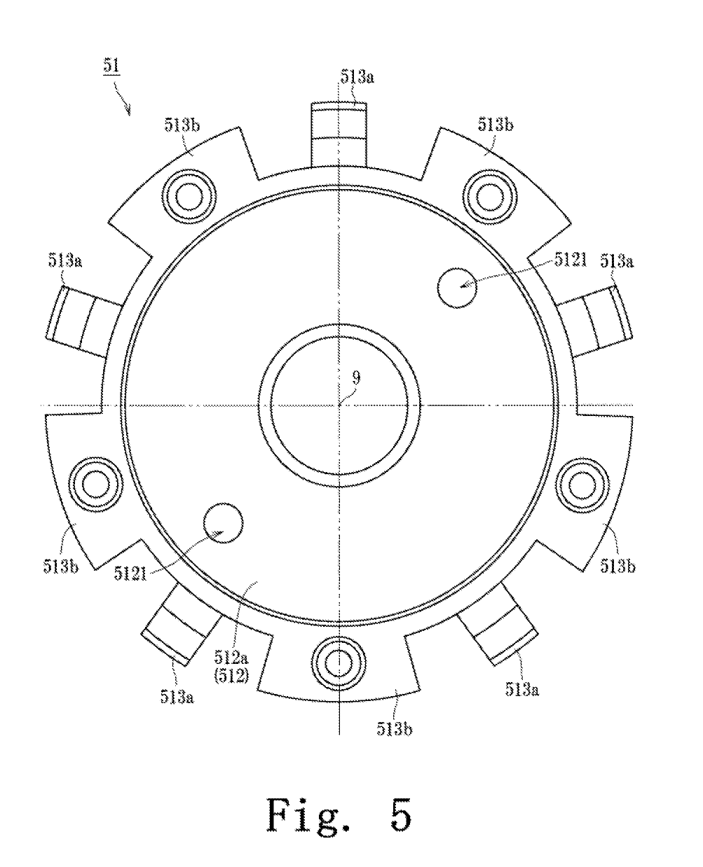

Subsequently, description will be made on the detailed shape of the cone 51. FIG. 3 is a top plan view showing the cone. FIG. 4 is a section view of the cone taken along line R-O-S in FIG. 3. FIG. 5 is a bottom view of the cone.

As shown in FIGS. 2 through 5, the cone 51 includes a cylinder portion 511, a flat portion 512, first guide portions 513a, second guide portions 513b and a storage portion 514. The cylinder portion 511 has an inner circumferential surface making contact with the outer circumferential surface of the first cylinder portion 421 of the rotor holder 42. The flat portion 512 extends radially outwards from the lower end of the cylinder portion 511. The first and second guide portions 513a and 513b (hereinafter generally referred to as “guide portions 513”) are arranged radially outwards of the flat portion 512 to guide the inner edge portion of the disk 90. The storage portion 514, which includes an annular indented portion, is positioned above the flat portion 512, radially inwards of the guide portions 513 and radially outwards of the cylinder portion 511. A space 514a for accommodating the clamp magnet 52 and the back yoke 53 is defined inside the storage portion 514. The cone 51 is a resin-molded article produced by injection-molding a resin. This makes it possible to mass-produce the cone 51 in a cost-effective manner. In the present embodiment, the outer circumferential surface 511b of the cylinder portion 511 makes up the inner wall of the storage portion 514. The flat portion 512 includes an upper surface 512b which defines a bottom surface of the storage portion 514. The inner circumferential surface 513c of the guide portions 513 makes up the outer wall of the storage portion 514.

The guide portions 513 will be described in more detail. In the present embodiment, as shown in FIG. 3, five first guide portions 513a and five second guide portions 513b are alternately arranged at regular intervals along the circumferential direction. However, the number of the guide portions 513a and 513b is not limited thereto.

Referring to FIG. 4, each of the first guide portions 513a is a hook-shaped portion including a first guide surface 513aa and a support surface 513ab. The first guide surface 513aa serves to guide the inner edge portion of the disk 90 and determine the radial position of the disk 90 when mounting the disk 90 in place. The support surface 513ab comes into contact with the inner edge portion of the disk 90 thus mounted. The tip end portions of the first guide portions 513a are slightly bent radially inwards when the disk 90 is mounted in place. This makes sure that the support surface 513ab makes reliable contact with the inner edge portion of the disk 90 regardless of the error in the inner diameter of disk 90. In this manner, the centering unit 5 brings the central axis of the disk 90 into alignment with the rotation axis 9.

Each of the second guide portions 513b includes a second guide surface 513ba and an outer circumferential surface 513bb. The second guide surface 513ba serves to guide the inner edge portion of the disk 90 when mounting the disk 90 in place. The outer circumferential surface 513bb is formed below the second guide surface 513ba. Preferably, the outer circumferential surface 513bb of the second guide portions 513b is positioned a little radially inwards of the support surface 513ab of the first guide portions 513a.

Next, description will be made on the flat portion 512 of the cone 51. As mentioned earlier, the lower surface of the flat portion 512 is made up of the planar surface 512a. In the present embodiment, unlike the prior art, the “planar surface” making up the lower surface of the cone 51 is not provided with a rib protruding downwards from the lower surface of the cone 51 nor a slit depressed upwards from the lower surface of the cone 51. As a result, it is possible to reduce the thickness of the flat portion 512 of the cone 51.

Protrusion portions 5122 protruding upwards are formed on the upper surface 512b of the flat portion 512. The protrusion portions 5122 according to the present embodiment are rod-shaped portions unitarily formed with the upper surface 512b of the flat portion 512. The protrusion portions 5122 are inserted into the accommodation portions 531 of the back yoke 53 to hold the back yoke 53 in place. From the standpoint of strength and parallelism, it is preferred that the protrusion portions 5122 be provided in plural number on the upper surface 512b of the cone 51 at regular intervals along the circumferential direction. This ensures that the back yoke 53 is stably held in the cone 51. Positioning portions 5121 including through-holes 5121a extending from the planar surface 512a of the flat portion 512 to the upper surface 512b thereof are formed at different positions than the protrusion portions 5122. The number of the positioning portions 5121 is not particularly limited. Preferably, two or more positioning portions 5121 are provided so that a worker should not make any mistake when attaching the cone 51 to a jig.

In the present embodiment, as shown in FIG. 3, four protrusion portions 5122 and two positioning portions 5121 are arranged along the same circle. The positioning portions 5121 mutually adjoining to each other are arranged at regular intervals along the circumferential direction. Likewise, the protrusion portions 5122 mutually adjoining to one another are arranged at regular intervals along the circumferential direction. In other words, it is preferred that four protrusion portions 5122 be positioned at regular intervals along the circumferential direction, each of the positioning portions 5121 being positioned in the circumferential middle position between two adjoining protrusion portions 5122. In this case, one of the positioning portions 5121 is spaced apart 180 degrees from the other. Since the protrusion portions 5122 and the positioning portions 5121 are equally spaced apart in this manner, it is possible to reduce occurrence of such defects as warp in a specific position during the course of molding the cone 51. As a consequence, it is possible to reduce occurrence of such defects as overall warp otherwise caused by the generation of positional bias. This makes it possible to prevent deformation of the cone 51.

It is preferred that recess portions formed in the areas with which release pins make contact in the resin molding process, called release pin traces 5125, are positioned at the circumferential opposite sides of the protrusion portions 5122. In the present embodiment, as shown in FIG. 3, eight release pin traces 5125 are formed in a corresponding relationship with four protrusion portions 5122 so that each of the protrusion portions 5122 can be interposed between two of the release pin traces 5125. Since the protrusion portions 5122 are arranged at regular intervals along the circumferential direction, the areas with which the release pins make contact in the resin molding process can also be released from a mold at regular intervals along the circumferential direction with no bias. There is no possibility that the release pins overlap with the protrusion portions 5122 or the positioning portions 5121. This assures increased stability during the molding and releasing processes.

Furthermore, it is preferred that the positional relationship between the protrusion portions 5122 and the positioning portions 5121 is set as follows. That is, the positioning portions 5121 mutually adjoining to each other are arranged at regular intervals along the circumferential direction. Likewise, the protrusion portions 5122 mutually adjoining to one another are arranged at regular intervals along the circumferential direction. Moreover, the positioning portions 5121 and the protrusion portions 5122 are arranged at regular intervals along the circumferential direction. In addition, the number of the protrusion portions 5122 is equal to the number of the positioning portions 5121 or a multiple of the positioning portions 5121. In the present embodiment, the number of the protrusion portions 5122 is four while the number of the positioning portions 5121 is two, which means that the number of the protrusion portions 5122 is two times of the number of the positioning portions 5121. This configuration provides a foolproof effect. In other words, no matter how the cone 51 is arranged on a jig by a worker, the positional relationship between the positioning portions 5121 and the protrusion portions 5122 is determined to be one kind.

Referring back to FIG. 2, the back yoke 53 is a hollow disc-shaped ferromagnetic body formed by a press work or other forming methods. The back yoke 53 is fixed within the storage portion 514 of the cone 51. The clamp magnet 52 of annular shape is adhesively fixed to the upper surface of the back yoke 53. The clamp magnet 52 has substantially the same outer diameter as that of the back yoke 53. The clamp magnet 52 and the back yoke 53 are accommodated within the storage portion 514. The clamp magnet 52 is a magnet arranged to generate axially-flowing magnetic flux. The back yoke 53 is a magnetic body arranged to improve the directivity of the magnetic fields generated from the clamp magnet 52. The clamp magnet 52 and the back yoke 53 generate a magnetic attraction force between them and a clamper yoke 131 of the clamper 13. Thus, the clamp magnet 52 and the back yoke 53 attract the clamper 13 toward the rotor holder 42.

When the disk 90 is mounted in place, the clamper 13 is attracted toward the rotor holder 42 by the magnetic attraction force acting between the clamp magnet 52 and the clamper 13. At this time, the clamper protrusion 132 of the clamper 13 is inserted into the clamper insertion portion 514b to be described later. This determines the radial position of the clamper 13. Thus, the clamper 13 comes closer to the disk mounting portion 424 and the disk 90 in a state that the rotation axis and radial center of the clamper 13 are substantially aligned with each other. As a consequence, the disk 90 is mounted in place in a state that it is gripped between the upper surface 42b of the rubber member 424 and the lower surface of the clamper 13. When the disk 90 is mounted in place, the first guide portions 513a of the cone 51 make contact with the inner edge portion of the disk 90 to decide the radial position of the disk 90 so that the center of the disk 90 is aligned with the center axis 9. The upper surface 42b of the rubber member 424 and the lower surface of the clamper 13 come into contact with the lower and upper surfaces of the disk 90, respectively, thereby deciding the axial position of the disk 90.

### 2-4. Detailed Shape of Back Yoke

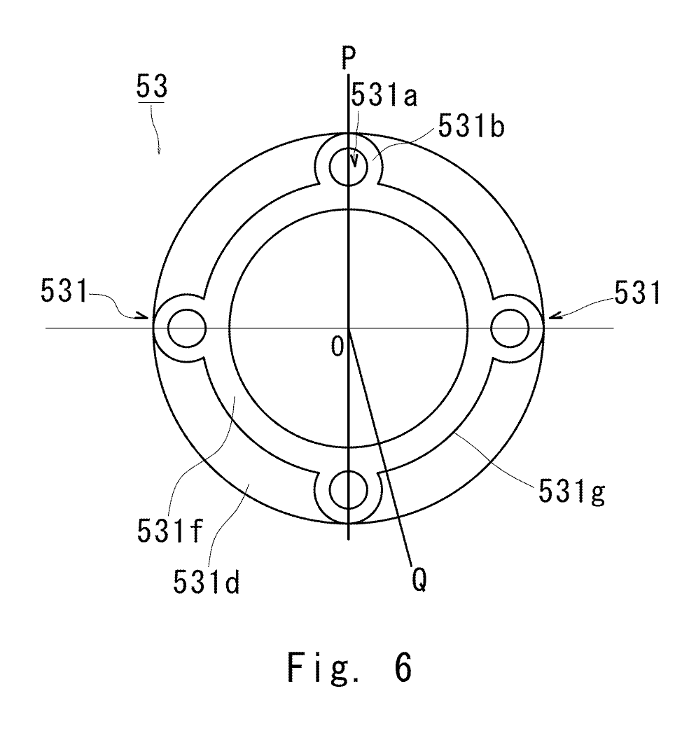

Next, the detailed shape of the back yoke 53 according to the present embodiment will be described with reference to FIGS. 6 through 8. The back yoke 53 includes accommodation portions 531 formed of insertion holes 531a axially extending through the back yoke 53. The protrusion portions 5122 of the flat portion 512 of the cone 51 are inserted into the accommodation portions 531. The number of the accommodation portions 531 is the same as the number of the protrusion portions 5122. When the center axis of the back yoke 53 is brought into alignment with the center axis of the flat portion 512 of the cone 51, the accommodation portions 531 are arranged to correspond in position to the protrusion portions 5122.

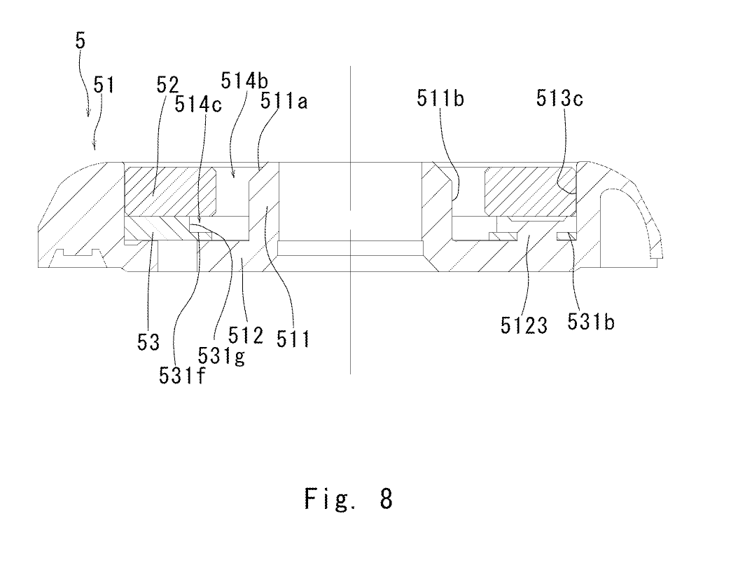

As shown in FIG. 8, the lower surface of the back yoke 53 is brought into contact with the upper surface 512b of the flat portion 512 of the cone 51. Then, the protrusion portions 5122 are accommodated within the accommodation portions 531. At this time, those portions of the protrusion portions 5122 protruding upwards beyond the top openings of the accommodation portions 531 are thermally deformed into enlarged portions 5123.

The accommodation portions 531 of the back yoke 53 according to the present embodiment include concave counter-bored portions 531b formed over the inner edges thereof to accommodate the enlarged portions 5123. Formation of the counter-bored portions 531b allows the resins of the thermally deformed protrusion portions 5122 to be accommodated within the counter-bored portions 531b as the enlarged portions 5123. Since the outer diameter of the enlarged portions 5123 is greater than the inner diameter of the accommodation portions 531, the enlarged portions 5123 are prevented from removal. This eliminates the possibility that the back yoke 53 is removed from the storage portion 514 of the cone 51. As a result, it becomes possible to stably fix the back yoke 53 to the cone 51, thereby manufacturing a centering unit 5 with increased reliability.

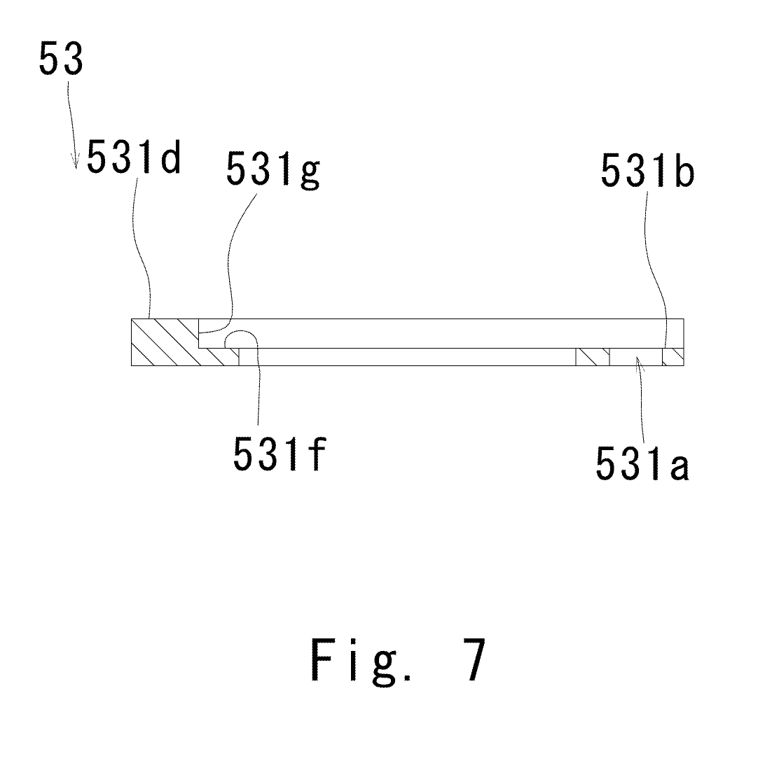

Referring to FIGS. 6 and 7, the back yoke 53 includes a first surface 531d, a second surface 531f and a step portion 531g. The first surface 531d is positioned at the axial upper side of the back yoke 53. The second surface 531f is positioned axially below the first surface 531d. The second surface 531f has an annular shape when seen in a plan view. The inner edge of the second surface 531f coincides with the inner edge of the back yoke 53. The step portion 531g is defined between the first surface 531d and the second surface 531f.

Referring to FIG. 8, the clamp magnet 52 of annular shape is arranged axially above the back yoke 53. The clamp magnet 52 is adhesively fixed to the first surface 531d of the back yoke 53. The second surface 531f is opposed to the clamp magnet 52 with an axial gap left therebetween. In the present embodiment, the second surface 531f is flush with the counter-bored portions 531b.

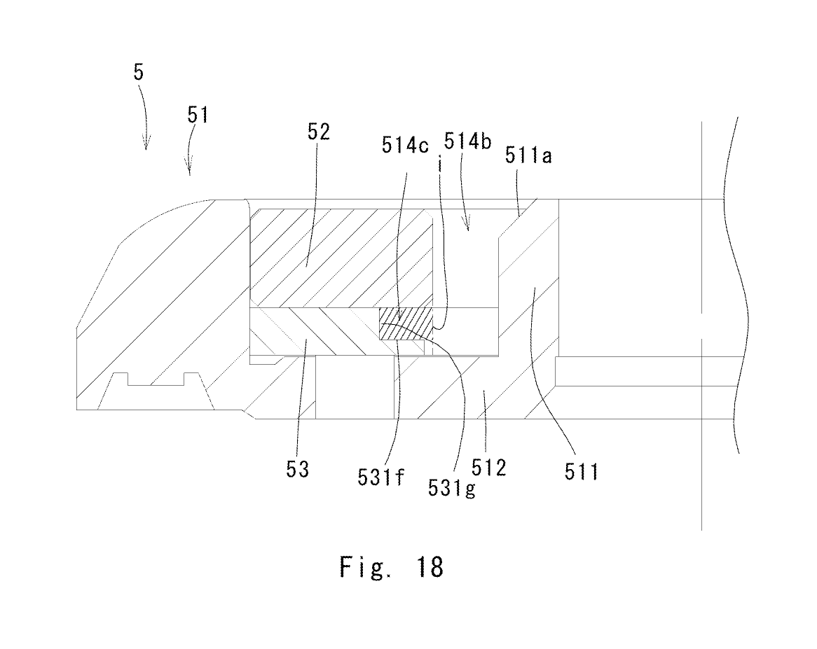

Referring to FIG. 18, a space is defined between the clamp magnet 52 and the back yoke 53, namely between the imaginary surface extending axially downwards from the inner circumferential surface of the clamp magnet 52, the lower surface of the clamp magnet 52, the step portion 531g and the second surface 531f. This space serves as an adhesive agent staying portion 514c. If the adhesive agent applied between the first surface 531d and the clamp magnet 52 flows out, it comes into the adhesive agent staying portion 514c.

A clamper insertion portion 514b is defined between the inner circumferential wall of the clamp magnet 52 including an imaginary surface extending in the axial direction along the inner circumferential wall of the clamp magnet 52 and the inner wall of the storage portion 514. The clamper protrusion 132 of the clamper 13 is inserted into the clamper insertion portion 514b. Thus, the clamper 13 comes closer to the disk mounting portion 424 and the disk 90 in a state that the radial center of the clamper 13 is substantially aligned with the rotation axis. A clamper guide portion 511a slanting axially upwards and radially inwards is formed in the upper extension of the outer circumferential surface of the cylinder portion 511 of the cone 51. When the disk 90 is mounted in place, therefore, the clamper protrusion 132 is guided by the clamper guide portion 511a so that the radial position of the clamper 13 can be smoothly decided even if the radial center thereof is a little out of alignment with the rotation axis.

In this regard, the outer diameter of the cone 51 cannot be increased due to the standardized inner diameter of the disk 90. Likewise, the inner diameter of the cone 51 cannot be reduced because there is a need to obtain a fastening force between the cone 51 and the shaft 41 or the rotor holder 42. This means that the clamper insertion portion 514b cannot be provided between the upper extension of the shaft 41 or the outer circumferential surface of the first cylinder portion 421 of the rotor holder 42 and the cylinder portion 511 of the cone 51. For that reason, the clamper insertion portion 514b needs to be formed within the storage portion 514 and in the area contiguous to the inner circumferential surfaces of the clamp magnet 52 and the back yoke 53. Even on this occasion, the adhesive agent does not infiltrate into the clamper insertion portion 514b because there is provided the adhesive agent staying portion 514c. This helps prevent the clamper protrusion 132 of the clamper 13 from making contact with the extruded adhesive agent.

In normal cases, the clamper 13 is attracted toward the clamp magnet 52 in a state that the disk 90 exists between the rotor holder 42 and the clamper 13. However, it is sometimes the case that, due to the erroneous operation of the disk drive apparatus or other causes, the clamper 13 is attracted toward the clamp magnet 52 with the disk 90 not existing between the rotor holder 42 and the clamper 13. On this occasion, there is a possibility that the clamper protrusion 132 of the clamper 13 moves downwards more deeply than the case where the disk 90 exists between the rotor holder 42 and the clamper 13. More specifically, the clamper protrusion 132 of the clamper 13 may possibly moves downwards beyond the clamp magnet 52 within the clamper insertion portion 514b. Even if such is the case, the adhesive agent does not infiltrate into the clamper insertion portion 514b due to the provision of the adhesive agent staying portion 514c. As a result, it is possible to prevent the clamper protrusion 132 of the clamper 13 from making contact with the extruded adhesive agent.

As set forth above, the centering unit 5 according to the present embodiment is capable of accurately positioning the clamper 13 with respect to the rotation axis 9 of the motor even if the lower surface of the flat portion 512 of the cone 51 is formed of the planar surface 512a. This makes it possible to reduce the thickness of the centering unit 5 while assuring the necessary and sufficient centering accuracy.

### 3. Centering Unit Manufacturing Method

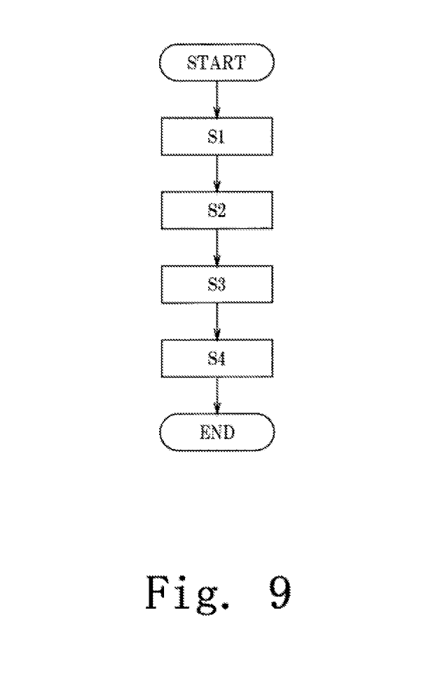

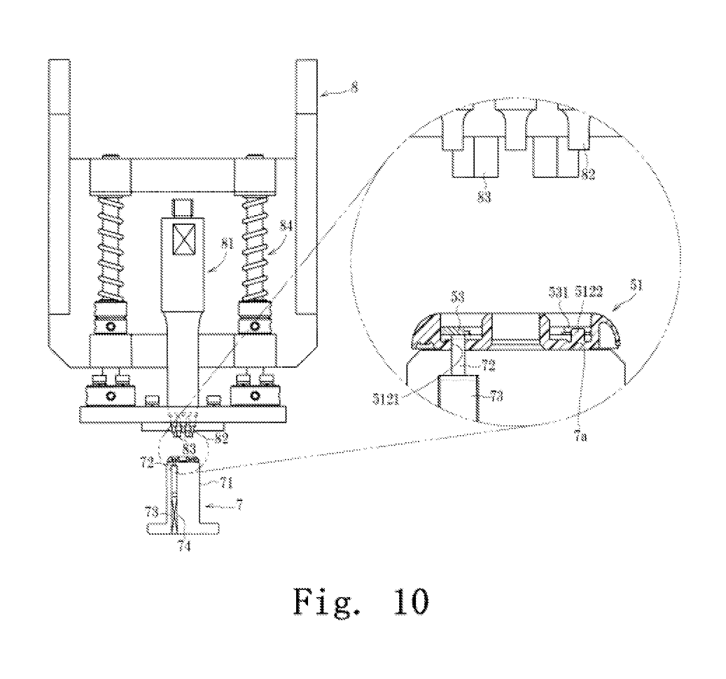

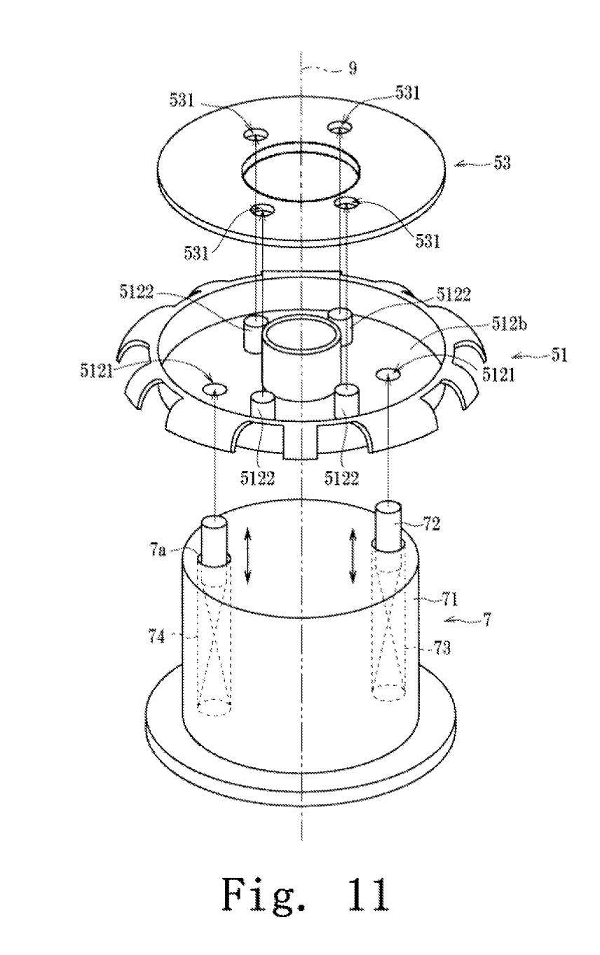

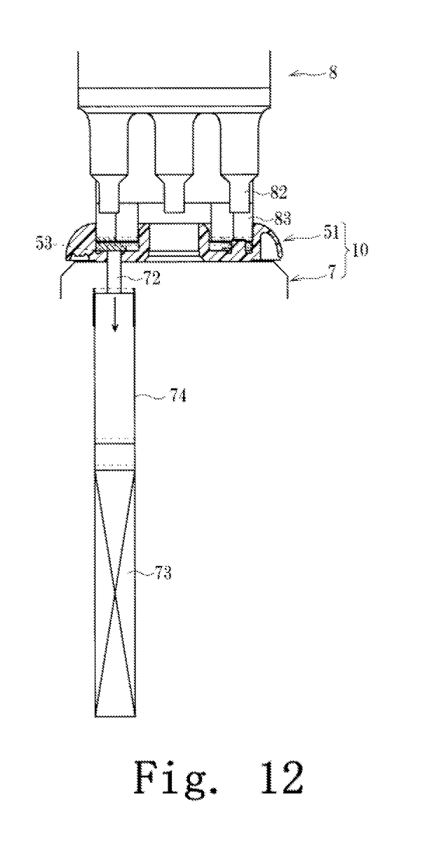

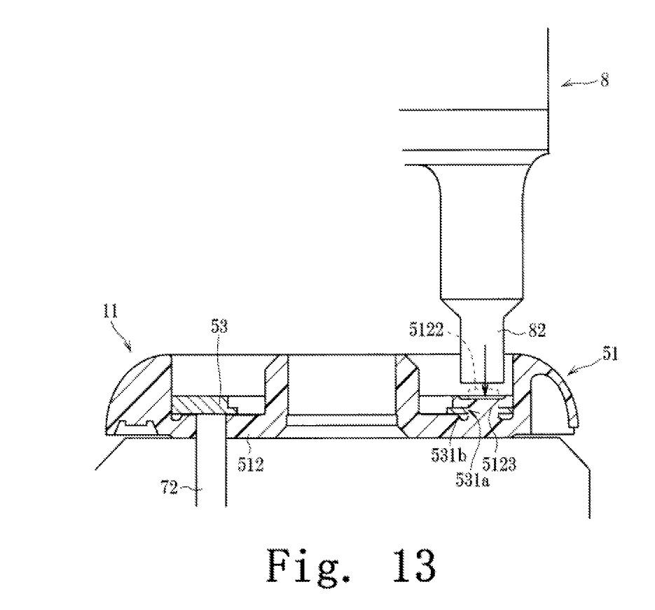

Next, a method for manufacturing the centering unit 5 will be described with reference to FIGS. 9 through 13. FIG. 9 is a flow chart illustrating the manufacturing sequence of the centering unit 5. FIG. 10 is a schematic diagram showing a supporting jig 7 and a pressing jig 8 used in the manufacture of the centering unit 5. FIG. 11 is an exploded perspective diagram showing the supporting jig 7, the cone and the back yoke 53, all of which are brought into alignment with the same axis. FIG. 12 is a view showing the centering unit 5 under manufacture, in which view the back yoke 53 is pressed by a pressing member 83. FIG. 13 is a view showing the centering unit 5 under manufacture, in which view each of the protrusion portions 5122 of the cone 51 is being melt by means of a horn 82.

The jigs used in the manufacture of the centering unit 5 according to the present embodiment include a pressing jig 8 and a supporting jig 7 provided axially below the pressing jig 8 in an opposing relationship with the latter. The pressing jig 8 is movable in the axial direction. The supporting jig 7 is kept immovable because it is fixed to a pedestal (not shown) having a surface perpendicular to the center axis 9.

### 3-1. Step of Attaching the Back Yoke 53 to the Cone 51

The supporting jig 7 will be described first. The supporting jig 7 is a jig used to temporarily fix the cone 51 on the upper surface thereof during the manufacture of the centering unit 5. The supporting jig 7 includes a positioning pin support portion 71 serving as a base, a top support surface 7a of the positioning pin support portion 71, positioning pins 72 and first biasing members 73. The top support surface 7a of the positioning pin support portion 71 is formed of a planar surface perpendicular to the center axis 9. The number of the positioning pins 72 is the same as the number of the positioning portions 5121 of the cone 51. The positioning pins 72 are arranged on the top support surface 7a in a corresponding positional relationship with the positioning portions 5121 of the cone 51 when the centers of the positioning pin support portion 71 and the cone 51 are aligned with the center axis 9. The positioning pins 72 have an outer diameter smaller than the inner diameter of the positioning portions 5121. The first biasing members 73 are attached to the lower end portions of the positioning pins 72 and are resilient enough to be extended and retracted in the axial direction. The first biasing members 73 primarily apply upward biasing forces to the positioning pins 72.

In the present preferred embodiment, as shown in FIG. 11, two closed-bottom positioning pin accommodation portions 74 each having a top opened at the top support surface 7a and a specified depth in the axial direction are arranged around the center axis 9 at regular intervals along the circumferential direction in a corresponding position and number to the positioning portions 5121 of the cone 51. The positioning pins 72 and the first biasing members 73 are partially accommodated within the closed-bottom positioning pin accommodation portions 74 along the axial direction. Preferably, the lower end portions of the first biasing members 73 are fixed to the bottoms of the positioning pin accommodation portions 74.

The sequence of fixing the cone 51 and the back yoke 53 together will now be described with reference to FIG. 11 which is a schematic diagram omitting some shapes of the back yoke 53. The cone 51 is prepared first (S1). Then, the supporting jig 7 and the cone 51 are arranged so that the axes thereof can be aligned with the center axis. At this time, the supporting jig 7 is arranged to lie below the cone 51. Upon brining the axes of the supporting jig 7 and the cone 51 into alignment with the center axis 9, the supporting jig 7 or the cone 51 is rotated in the circumferential direction to adjust the relative position thereof so that the positioning portions 5121 of the cone 51 can correspond in position to the positioning pins 72 of the supporting jig 7.

Next, the positioning pins 72 are inserted into the positioning portions 5121. At this time, the cone 51 is placed on the supporting jig 7 with the lower surface 512a of the cone 51 opposed to the top support surface 7a of the supporting jig 7. This ensures that the cone 51 is securely fixed to the supporting jig 7 with increased accuracy and parallelism. This also makes it possible to prevent the cone 51 from rotating in the circumferential direction. When the cone 51 is placed on the supporting jig 7, the positioning pins 72 of the supporting jig 7 protrude from the upper openings of the positioning portions 5121 of the cone 51.

Subsequently, the back yoke 53 is placed within the storage portion 514 of the cone 51 to lie above the flat portion 512 of the cone 51. Specifically, the center axis 9 of the unit formed of the supporting jig 7 and the cone 51 (hereinafter referred to as “first unit 10”) is brought into alignment with the center axis 9 of the back yoke 53. At this time, the first unit 10 is arranged below the back yoke 53. When the respective center axes 9 are aligned with each other, the circumferential position of the cone 51 or the back yoke 53 is adjusted so that the protrusion portions 5122 of the cone 51 can correspond in position with the accommodation portions 531 of the back yoke 53. Then, the back yoke 53 is moved down to insert the protrusion portions 5122 into the accommodation portions 531. Any rotation of the back yoke 53 in the circumferential direction can be prevented by inserting the protrusion portions 5122 of the cone 51 into the accommodation portions 531 of the back yoke 53.

At this time, the lower surface 531c of the back yoke 53 is supported by the positioning pins 72 of the supporting jig 7 protruding from the upper openings of the positioning portions 5121 of the cone 51. As a result, the first biasing members 73 attached to the lower end portions of the positioning pins 72 are retracted downwards by the weight of the back yoke 53. Thus, the axial positions of the positioning pins 72 are further displaced downwards. Since two positioning pins 72 are spaced apart 180 degrees from each other and four protrusion portions 5122 are arranged at regular intervals, it is possible to accurately keep the parallelism of the back yoke 53 while allowing the upper end portions of the positioning pins 72 to support the back yoke 53. It is also possible to reduce the fear that the back yoke 53 is arranged within the storage portion 514 of the cone 51 in a tilted state. In the following description, the unit formed of the first unit 10 and the back yoke 53 will be referred to as “second unit 11”.

When the back yoke 53 is supported by the upper end portions of the positioning pins 72 of the supporting jig 7, it is desirable that the upper end extensions of the protrusion portions 5122 be positioned higher than the lower surface of the back yoke 53. Otherwise, the rotation of the back yoke 53 would be prevented. Such a problem can be reduced by arranging even a little bit of the upper end extensions of the protrusion portions 5122 within the accommodation portions 531 of the back yoke 53.

Next, description will be made on the pressing jig 8 used in a fusion fixing process. The pressing jig 8 serves not only as a pressing device for pressing the back yoke 53 into the storage portion 514 of the cone 51 but also as a fusion fixing device for thermally deforming the resin-made protrusion portions 5122 to fix the back yoke 53. The pressing jig 8 includes a horn body 81, horns 82, pressing members 83 and second biasing members 84. When the center axes 9 of the horn body 81 and the second unit 11 are brought into alignment with each other, the horns 82 are provided in the lower end portion of the horn body 81 in a corresponding position and number to the protrusion portions 5122 of the cone 51. Each of the horns 82 includes a heat generator (not shown) arranged to heat and deform the tip end of each of the protrusion portions 5122. The heat generator is used in increasing the temperature of the area around the lower end portion of each of the horns 82 and may be, e.g., an ultrasonic device arranged to generate frictional heat through ultrasonic vibration. The pressing members 83 are provided in the lower end portion of the horn body 81 and are arranged in different positions than the horns 82. The pressing members 83 are capable of pressing the upper surface of the back yoke 53. The second biasing members 84 are attached to the upper end portions of the pressing members 83 and are resilient enough to be extended and retracted in the axial direction. The second biasing members 84 primarily apply downward biasing forces to the pressing members 83. The horns 82 are preliminarily positioned so that they can make contact with only the protrusion portions 5122 of the cone 51 and not the back yoke 53.

Next, description will be made on a step of bringing the back yoke 53 into contact with the upper surface 512b of the flat portion 512. First, the lower end portions of the pressing members 83 of the pressing jig 8 are brought into contact with the upper surface 531d of the back yoke 53. Then, the back yoke 53 is pressed downwards with the pressing jig 8 while maintaining the parallelism of the back yoke 53. Finally, the lower surface 531c of the back yoke 53 is brought into contact with the upper surface 512b of the flat portion 512. The pressing jig 8 is configured so that the lower end portions of the pressing members 83 can be positioned axially lower than the lower end portions of the horns 82.

Subsequently, the back yoke 53 is sandwiched between the positioning pins 72 and the pressing members 83 and is provisionally fixed in the axial direction. The protrusion portions 5122 of the cone 51 are inserted into the four accommodation portions 531 of the back yoke 53 to provisionally fix the back yoke 53 in the circumferential direction. In this state, the fusion fixing step proceeds. First, the back yoke 53 is brought into contact with the upper surface 512b of the flat portion 512 by the downward biasing forces of the second biasing members 84, in which state the horns 82 of the pressing jig 8 are put on the protrusion portions 5122 of the cone 51 protruding from the accommodation portions 531 of the back yoke 53. At this time, the second biasing members 84 are retracted so that the horns 82 can be moved down while pressing the pressing members 83 against the back yoke 53.

Then, the horns 82 are pressed against the protrusion portions 5122 of the cone 51, and the enlarged portions 5123 are formed by vibrating and thermally deforming the protrusion portions 5122 of the cone 51. At this time, the protrusion portions 5122 can be thermally deformed with no misalignment of the back yoke 53 while pressing the back yoke 53 with the pressing members 83. Thus, the back yoke 53 can be fixed to the cone 51 with increased accuracy. In this manner, the enlarged portions 5123 are prevented from removal with respect to the back yoke 53. Consequently, the back yoke 53 is fixed to the cone 51.

In the accommodation portions 531 of the back yoke 53 according to the present embodiment, there are provided the counter-bored portions 531b extending over the inner edges of the accommodation portions 531 to accommodate the enlarged portions 5123.

The counter-bored portions 531b according to the present preferred embodiment are formed to have a concave shape when seen in a section view, thereby providing step-like shoulders. The resins of the protrusion portions 5122 thermally deformed by the horns 82 are cured in the counter-bored portions 531b and fixed thereto as the enlarged portions 5123.

Formation of the counter-bored portions 531b allows the resins of the thermally deformed protrusion portions 5122 to be accommodated within the counter-bored portions 531b as the enlarged portions 5123. Since the outer diameter of the enlarged portions 5123 is greater than the inner diameter of the accommodation portions 531, the enlarged portions 5123 are prevented from removal. This eliminates the possibility that the back yoke 53 is removed from the storage portion 514 of the cone 51. As a result, it becomes possible to stably fix the back yoke 53 to the cone 51, thereby manufacturing a centering unit 5 with increased reliability (S2).

### 3-2. Adhesive Agent Applying Step

Next, an adhesive agent is applied on the radial outer area of the first surface 531d of the back yoke 53, namely on the annular area perpendicular to the center axis J1 (S3). At this time, the application quantity of the adhesive agent is determined as appropriate. Alternatively, the adhesive agent may be applied on the lower surface of the clamp magnet 52.

### 3-3. Clamp Magnet Fixing Step

Next, a step of fixing the clamp magnet 52 to the cone 51 and the back yoke 53 will be described with reference to FIG. 8. First, the magnetized clamp magnet 52 is inserted into the storage portion 514 from above the back yoke 53 while bringing the center of the clamp magnet 52 into alignment with the center axis J1. In this regard, the inner diameter of the outer wall of the storage portion 514, i.e., the inner circumferential surfaces 513c of the guide portions 513, is substantially equal to the outer diameter of the clamp magnet 52. This makes it possible to bring the center of the clamp magnet 52 into alignment with the center axis J1 with ease. The clamp magnet 52 is magnetized in advance. Therefore, the clamp magnet 52 is strongly brought into contact with the first surface 531d by the magnetic attraction force acting between the clamp magnet 52 and the back yoke 53 and is fixed to the upper surface of the back yoke 53 through the adhesive agent. At this time, as the clamp magnet 52 makes contact with the back yoke 53, a part of the adhesive agent may possibly be leaked outwards from between the back yoke 53 and the clamp magnet 52. In the present embodiment, however, the adhesive agent is gathered within the adhesive agent staying portion 514c even if it is leaked from between the back yoke 53 and the clamp magnet 52. This eliminates the possibility that the adhesive agent is leaked out of the adhesive agent staying portion 514c. Therefore, the adhesive agent is not leaked into the clamper insertion portion 514b. As a result, the clamper protrusion 132 can be smoothly inserted into the clamper insertion portion 514b.

In the present embodiment, the bottom surfaces of the counter-bored portions 531b and the second surface 531f are interconnected to each other. Therefore, the areas of the counter-bored portions 531b where the enlarged portions 5123 do not exist can also be used as the adhesive agent staying portion 514c. Furthermore, since the bottom surfaces of the counter-bored portions 531b are flush with the second surface 531f, it is possible to easily form the counter-bored portions 531b and the second surface 531f with a press mold.

Finally, the adhesive agent existing between the clamp magnet 52 and the back yoke 53 is solidified to thereby fix the clamp magnet 52 and the back yoke 53 together. In this manner, the clamp magnet 52 and the back yoke 53 can be fixed together (S4).

### 4. Other Embodiments

While one embodiment of the present invention has been described hereinabove, the present invention is not limited thereto.

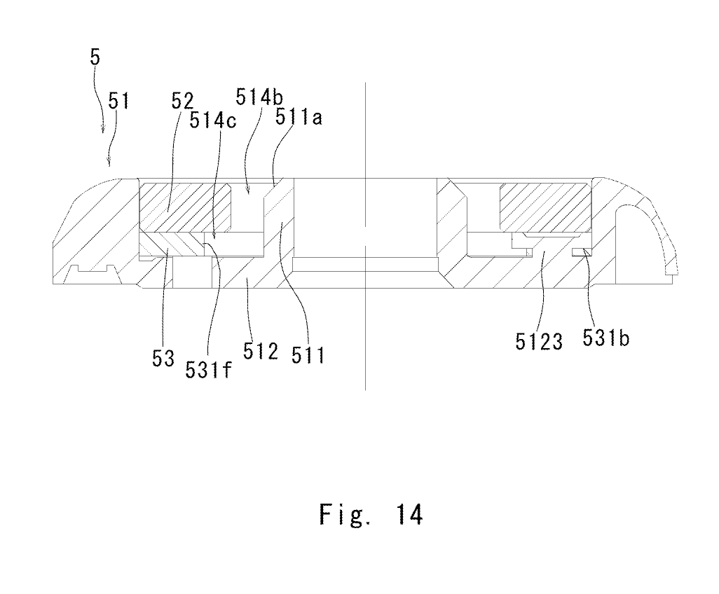

For example, although the second surface 531f of the back yoke 53 is flush with the counter-bored portions 531b according to the foregoing embodiment, the present invention is not limited thereto. As shown in FIG. 14, the inner circumferential surface of the back yoke 53 may serve as the second surface 531f.

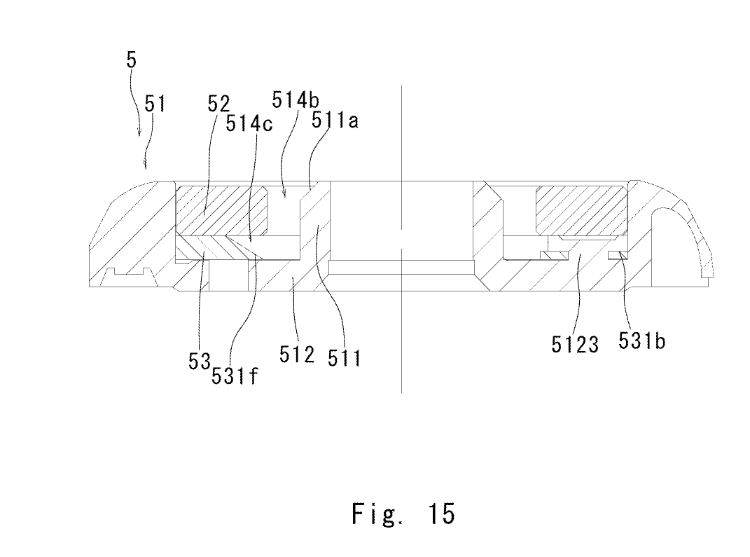

As shown in FIG. 15, the second surface 531f may be a slant surface.

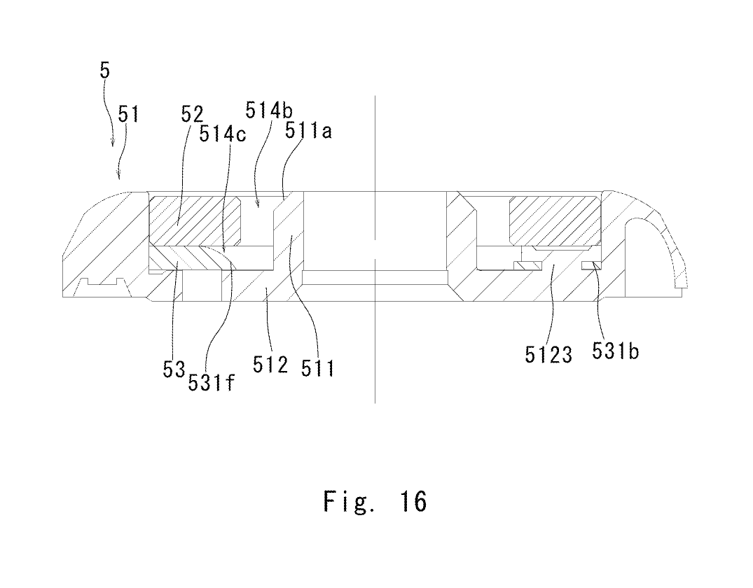

As shown in FIG. 16, the second surface 531f may be a curved surface.

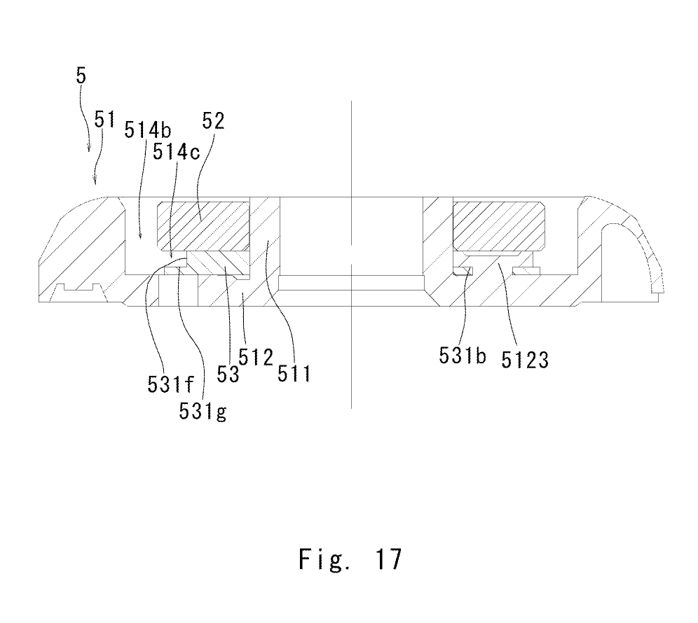

As shown in FIG. 17, the clamper insertion portion 514b may be arranged radially outwards of the clamp magnet 52. In this case, the clamper guide portion 514b may be formed in the upper extension of the outer wall of the storage portion 514.

Although the outer diameter of the back yoke 53 is substantially equal to the outer diameter of the clamp magnet 52 in the above description, the present invention is not limited thereto. For example, the outer diameter of the back yoke 53 may be different from the outer diameter of the clamp magnet 52.

Although the back yoke 53 is fixed by a fusion fixing method, the present invention is not limited thereto. For example, the back yoke 53 may be fixed by press-fit or insert-molding.

Although the back yoke 53 has an annular shape, the present invention is not limited thereto. For example, the back yoke 53 may have a partially cut-away “C” shape.

In the foregoing embodiment, it is desirable that at least a portion of the back yoke 53 and the upper surface 42b of the disk mounting portion 424 be positioned within the axial dimension of the guide portions 513. This is because the present invention may be applied to a low-profile motor in which the guide portions 513, the disk mounting portion 424 and back yoke 53 are arranged in an axially overlapping state.

In the foregoing embodiment, the accommodation portions 531 of the back yoke 53 is provided with the insertion holes 531a and the counter-bored portions 531b. However, it is not always necessary to provide the counter-bored portions 531b. It may be possible to provide only the insertion holes 531a (or the accommodation portions 531) extending through the back yoke 53. In this case, it is preferred that the insertion holes 531a (or the accommodation portions 531) be formed into a tapering shape so that the inner diameter thereof can be gradually increased from the lower surface side toward the upper surface side.

The advantageous effects mentioned above can also be attained by forming the counter-bored portions 531b into a tapering shape so that the inner diameter thereof can be gradually increased from the lower side toward the upper side.

Although the cone 51 is fixed to the shaft 41 through the rotor holder 42 according to the foregoing embodiment, the cone 51 may be directly fixed to the shaft 41.

In the foregoing embodiment, description has been made on the cone 51, the chucking device 4, the brushless motor 12 and the disk drive apparatus 1 for use with the optical disk 90. However, the present invention may be applied to other kinds of cones, chucking devices, motors and disk drive apparatuses, which are designed to support magnetic disks or the like.

What is claimed is:

1. A motor for a disk drive apparatus, which is rotatable about a rotation axis and arranged to hold a disk in cooperation with a clamper provided in a disk drive apparatus body, the motor comprising:
a cone member including a flat portion expanding radially away from the rotation axis, a guide portion arranged radially outwards of the flat portion and provided with a guide surface for guiding the inner edge portion of the disk and a storage portion positioned above the flat portion and radially inwards of the guide portion;
a substantially annular back yoke arranged within the storage portion of the cone member;
a substantially annular clamp magnet positioned axially above the back yoke to attract the clamper;
an adhesive agent arranged to fix the clamp magnet to the cone member and/or the back yoke; and
a motor unit arranged to rotate the cone member,
wherein the storage portion includes a clamper insertion portion formed in a position axially overlapping with the clamp magnet to accommodate the clamper when the clamper comes closer to the cone member, the back yoke including a first surface opposed to the clamp magnet in a contact or adjoining relationship therewith and a second surface positioned near the clamper insertion portion and kept spaced apart from the clamp magnet, the cone member including an adhesive agent staying portion arranged to accommodate a part of the adhesive agent, the adhesive agent staying portion being defined between the imaginary surface extending axially downwards from the circumferential surface of the clamp magnet facing the clamper insertion portion, the lower surface of the clamp magnet and the back yoke including the second surface or between the imaginary surface, the lower surface of the clamp magnet, the back yoke including the second surface and the upper surface of the cone member.

2. The motor of claim 1, wherein the clamper insertion portion is formed inside the clamp magnet.

3. The motor of claim 3, wherein the inner diameter of the back yoke is smaller than the inner diameter of the clamp magnet.

4. The motor of claim 3, wherein the back yoke includes a step portion formed on the inner circumference thereof to extend away from the lower surface of the clamp magnet.

5. The motor of claim 1, wherein the second surface is gradually inclined axially downwards as the second surface comes closer to the clamper insertion portion.

6. The motor of claim 1, wherein the second surface is gradually curved axially downwards as the second surface comes closer to the clamper insertion portion.

7. The motor of claim 1, wherein the cone member includes a clamper guide portion formed at the upper side of the clamper insertion portion.

8. A disk drive apparatus comprising:
the motor of claim 1;
a clamper attracted by the clamp magnet to hold the disk;
a recording and reproducing unit arranged to read information from the disk and/or to write information on the disk; and
a housing arranged to accommodate the motor, the clamper and the recording and reproducing unit therein,
wherein the clamper includes a clamper protrusion for insertion into the clamper insertion portion.

9. A method for manufacturing a centering unit used in a motor for a disk drive apparatus which is rotatable about a rotation axis and arranged to hold a disk in cooperation with a clamper provided in a disk drive apparatus body, the method comprising the steps of:
preparing a cone member;
fixing a back yoke to the cone member;
applying an adhesive agent on at least the upper surface of the back yoke and/or the lower surface of the clamp magnet; and
placing the magnet clamp on the upper surface of the back yoke in a magnetized state,
wherein the centering unit includes a clamper insertion portion formed in a position axially overlapping with the clamp magnet to accommodate the clamper when the clamper comes closer to the cone member, the back yoke including a first surface making up the top surface of the back yoke and a second surface positioned lower than the first surface, the centering unit including an adhesive agent staying portion defined between the imaginary surface extending axially downwards from the circumferential surface of the clamp magnet facing the clamper insertion portion, the lower surface of the clamp magnet and the back yoke including the second surface or between the imaginary surface, the lower surface of the clamp magnet, the back yoke including the second surface and the upper surface of the cone member, the adhesive agent staying portion being arranged to accommodate, during the placing step, a part of the adhesive agent applied on at least the upper surface of the back yoke and/or the lower surface of the clamp magnet in the applying step.
